(19) United States
(12) Patent Application Publication
(10) Pub. No.: US 2018/0089602 A1
(43) Pub. Date: Mar. 29, 2018

(54) TRANSFORMATION OF PROCESS MODEL SPECIFICATION BETWEEN FORMATS

(71) Applicant: SAP SE, Walldorf (DE)

(72) Inventors: David Sierro Elvira, Heidelberg (DE); Eudes Canuto, Chicago, IL (US)

(73) Assignee: SAP SE, Walldorf (DE)

(21) Appl. No.: 15/280,503

(22) Filed: Sep. 29, 2016

(51) Int. Cl. G06Q 10/06

(52) U.S. Cl. CPC G06Q 10/0633

(57) ABSTRACT

Technologies are described for facilitating definition and implementation of a process model. A specification of a process model is received in a first format. The specification of the process model is transformed into a second format.

### FIELD

The present disclosure generally relates to computer-implemented process modeling. Particular implementations relate to transforming a process model specification from a first format to a second format.

### BACKGROUND

Process models, such as workflow models, can help ensure that processes are well defined and efficient. Process models can also help ensure that a process is followed in a consistent manner.

Computer-implemented process modeling can provide various benefits. For example, it can facilitate the process of creating or editing a process model. Computing systems can also be used to oversee the execution or implementation of the modeled process. For example, at least certain steps of the process can be carried out using a computing system, or the results of conducting process steps can be entered into the computer system. A computer implemented process model can facilitate executing process steps and tracking execution progress.

However, implementing a process model in a computing system can be significantly more complex than creating a graphical representation of the process model. This complexity can result in significantly more resources being needed to implement a process model, and limit the implementation of the process model to users having the necessary technical skills. In addition, in some cases, an implementation of a process model may not be compatible with other software associated with the process, such as online collaboration tools.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques and solutions are described for creating or executing process model specifications, such as a workflow model. According to a particular method, a specification of a process model is received in a first format. The process model includes a plurality of related process steps. The specification of the process model is transformed from a first format into a second format. In a particular implementation, the first format is a graphical representation of the process model specification, such as a process model created using the Unified Modeling Language (UML) or Business Process Model and Notation (BPMN). In further implementations, the second format is a computer-executable representation of the process model, such as a model or other representation of the process in a programming language, such as Advanced Business Application Programming (ABAP), a markup language, or a combination of a programming language and a markup language.

The method can include additional steps. For example, the method can include executing (or otherwise implementing) the specification of the process model. For example, the specification of the process model can guide or otherwise facilitate one or more users in carrying out the modeled process, including tracking the status of process steps and controlling the progression of the process.

The method can also include steps relating to the definition of the specification of the process model. For example, the method can include receiving user input defining the specification of the process model. In some cases, the method can provide the user with selectable graphical elements representing various process steps that the user can select to build the specification of the process model.

The method can also include facilitating collaboration associated with the modeled process, and providing access to information associated with the modeled process. For example, implementation of the specification of the process model can include issuing invitations to users to become associated with the process, or to request user input, such as approval, of process model items or steps. In some cases, the process model can be associated with a central repository of user information or a collaboration tool or component, such as an online collaboration component. The online collaboration component can facilitate communication among users associated with the process model, and can include information, such as documentation, related to the process model.

The present disclosure also includes computing systems and tangible, non-transitory computer readable storage media configured to carry out, or including instructions for carrying out, an above-described method. As described herein, a variety of other features and advantages can be incorporated into the technologies as desired.

### BRIEF DESCRIPTION OF THE DRAWINGS

FIG. 1 is a diagram of a process model specification having a plurality of process components, and callouts displaying information regarding the process model.

FIG. 2 is a diagram of an example display of a status network, including display windows providing information of a collaboration platform relating to the status network and actions that have occurred during execution of a workflow associated with the status network.

FIG. 3A is a diagram of process model specification having a plurality of process components, a process model pallet for creating or editing a process model specification, and a callout providing for configuration of process model components.

FIG. 3B is a diagram illustrating a method for transforming a process model specification from a first format to a second format.

FIG. 4 is a block diagram illustrating an example software architecture in which a framework can communicate with a client application, a database, and an application suite to carry out embodiments of the present disclosure for creating and implementing a process model.

FIG. 5 is a block diagram illustrating an example software architecture having a server with a user interface and one or more clients or branches, each client or branch being associated with a process model, where the server is in communication with integrated and external information sources.

FIG. 6 is a block diagram illustrating an example software architecture having a workflow engine in communication with a user interface, a rules framework, and a plurality of additional components.

FIG. 7 is a block diagram illustrating methods for creating or implementing a workflow model specification according to an embodiment of the present disclosure.

FIG. 8 is a block diagram illustrating a method for creating and implementing a workflow model specification according to an embodiment of the present disclosure.

FIG. 9 is a flowchart illustrating a method for users to collaborate in implementing a workflow according to an embodiment of the present disclosure.

FIG. 10 is a diagram illustrating a method for implementing a workflow model specification using a workflow engine in communication with a collaboration component according to an embodiment of the present disclosure.

FIG. 11 is a flowchart of a method of transforming a process model specification from a first format to a second format according to an embodiment of the present disclosure.

FIG. 12 is a diagram of an example computing system in which some described embodiments can be implemented.

FIG. 13 is an example cloud computing environment that can be used in conjunction with the technologies described herein.

### DETAILED DESCRIPTION

### Example 1—Overview

Organizations commonly implement various processes, which can be referred to as workflows, to carry out various business functions. A single organization may have many different workflows. For example, an organization may have workflows for hiring employees, terminating employees, paying employees, creates sales orders, defining sales processes, developing products, purchasing goods and services, and tracking the finances of the organization. However, the present disclosure is not limited to workflows, or any particular process.

Software can facilitate the planning or execution or implementation of workflows. For example, workflows can be implemented in software, and various steps, such as workflow items, can be at least partially carried out using the software. For example, some workflow items can require the approval of a particular individual (or an individual having a certain role, such as a manager). Software can facilitate notifying an authorizing individual that an item is awaiting their approval, as well as providing for electronic approval.

While software can facilitate workflow creation and execution, defining the workflows for execution by the software can be a complex process, which may be time consuming for users. In addition, the technical knowledge needed to define an executable workflow may be outside the expertise of many users.

Various schemas have been created to model processes, including workflows. For example, workflows can be defined in the Unified Modeling Language (UML) or Business Process Model and Notation (BPMN). These tools can provide standardized ways for defining, or modeling, processes, such as workflows. However, in at least some cases, a schema used to define a process model specification may not integrate with a software component used to implement the process model specification, such as software implementing a workflow model specification.

That is, a user may create a representation, or specification, of the workflow model using a schema such as UML or BPMN, but then the user, or another user (such as a programmer or application specialist) may need to separately define the workflow model specification in another format, such as a format executable by the software component responsible for implementing the workflow model specification. In addition, software responsible for implementing the workflow model specification may not be integrated with, or may be difficult to integrate with, other software components used by an organization or user, such as a collaboration platform.

The present disclosure can provide a method, including computer systems and tangible, non-transitory storage medium implementing the method, for defining or modifying a process model specification, such as a workflow model specification, and for executing the process model, that are more user friendly. For example, the method may make it faster to implement a process model specification in software, or implementation of the process model specification may require less technical knowledge or skill on the part of a user. The present disclosure can also provide a method, including computer systems and tangible, non-transitory storage medium implementing the method, for process model specification creation or execution, such as using a software tool, that may facilitate integration with other software components, such as a collaboration component.

### Example 2—Transforming Process Model Specification Between Formats

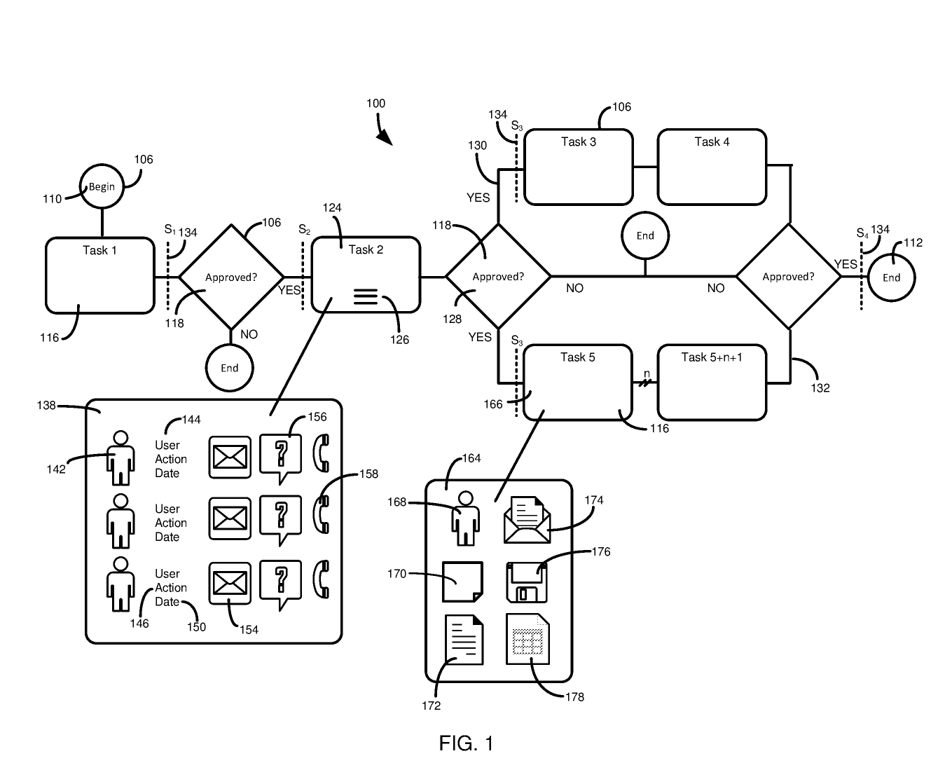

FIG. 1 illustrates an example process model 100 specification, specifically, a graphical representation of a workflow model specification. Although FIG. 1 illustrates a workflow model, FIG. 1, and this Example 2, can be used with other types of processes and process models.

The workflow model specification 100 can have various components or steps 106. The components 106 may also be referred to as workflow items. The components 106 can include a start block 110 and an end block 112. The components 106 can also include tasks 116 and gateways (such as decisions) 118.

Each type of component 106 can be associated with a particular graphical representation to help identify the type of component. For example, start and end blocks 110, 112 may be represented by circles. Tasks 116 may be represented by rectangles with rounded corners. Gateways 118 may be represented by diamonds. A particular workflow model specification 100 may include more, fewer, or different components 106 than shown in FIG. 1. In addition, particular components 106 are not limited to particular shapes. However, in some implementations, components 106 can be components defined in a standard representation, such as UML or BPMN.

In some cases, a particular task 116 (or other component 106) may be repeated more than one time before the workflow model 100 progresses to the next component. In general, the task 116 (or, in some cases, other components 106) can be repeated until a certain condition occurs. In particular implementations, the condition can be the task 116 having been executed at least a threshold number of times. The task 116, in some cases, can have a graphical notation indicating that the task may (or must) be repeated. For example, task 124 includes a notation 126 (three horizontal lines or bars) indicting that the task 124 is to be repeated three times before the workflow model 100 proceeds to the gateway 128.

In addition to loops, the workflow model specification 100 can include branches, such as branches 130, 132. Branches can be used for subprocesses of the workflow model 100 which should (or can) be performed in parallel. For example, the workflow model 100 may include tasks 116, or other workflow components 106, that are to be performed in parallel. In some cases, branches can be used when multiple approvals are needed before a primary process of the workflow model 100 proceeds to the next component 106. In some examples, rather than multiple approvals being required for the primary process to proceed, less than all approvals associated with a particular branching point are sufficient to allow the primary process to continue. In a particular case, a single approval is sufficient to allow the primary process to proceed.

A branch can include a fork, where a primary process spits into branches. Two or more branches can also join (including rejoining) together. In various examples, branches can fork, but not rejoin, or can join without having formed from another process (that is, the subprocesses can start as separate processes and then join a primary process). Branches may include one or more sub-branches. As shown in FIG. 1, branches 130, 132 fork and then rejoin.

According to some aspects, the workflow 100 can be divided into one or more stages 134 representing the status of the workflow. Displaying a large number of tasks 116, or other workflow components 106, can make the workflow 106 difficult to follow. In some cases, dividing a workflow 100 into statuses can allow the workflow 100 to be simplified, such as by organizing the workflow into significant stages.

For example, prior to approval at 118, the workflow 100 can be in a status S₁. After approval at 118, the workflow 100 can move to a status S₂. In some cases, a status 134 can include a loop in the workflow 100, such as status S₂. A status 134 can also be part of a branched portion of the workflow 100, such as in status S₃. For instance, status S₃ includes two tasks 116 in branch 130, and branch 132 includes Task 5 and 5+n+1 additional tasks (where n can be 0, 1, or more than 1).

In particular embodiments, a computing system is provided that displays the workflow model specification 100 to a user. The user may select various components 106, such as to take action regarding the component 106 (e.g., provide an approval or denial regarding a gateway 118, or take action regarding a task 116) or to obtain information regarding a component. For example, a user may wish to obtain information regarding the status of a component 106, determine individuals associated with the component, or view notes, documents, records, or other information regarding the component.

FIG. 1 illustrates an example of information a user may obtain by selecting a particular component 106, such as task 124. The information may be presented in a callout 138. The callout 138 can include information such as users who have viewed, taken action, or are otherwise associated with the task 124. For example, the callout 138 can include a picture 142 or icon representing a particular user. The callout 138 can also include an identifier 144 for the user (e.g., the user's name), a description 146 of action taken by the user (or, for example, the user's role or action needed to be taken by the user), and a date 150 associated with the action 146.

The callout 138 may also provide ways of contacting a user associated with an action 146, such as by providing an icon 154 to send the user an email, an icon 156 to send the user a messenger request (such as a text message or an instant message), or an icon 158 to place a telephone call to the user. The callout 138 represents a particular way of presenting particular information to a user. In other embodiments, information can be presented in a different manner, and may include more, less, or different information than shown in callout 138, and the information may be presented in other formats or other manners.

Callout 164 presents additional information that may be presented to a user regarding a component 106, in this case for task 166. Callout 164 presents options a user may select to obtain various kinds of information, but also may be used to present a user with actions that may be taken regarding the component 106. For example, callout 164 can provide a user icon 168 which can be selected to provide more information regarding users associated with task 166 or, in some cases, to add, remove, or otherwise modify users or user roles associated with the task.

The callout 164 can include a notes icon 170 which can be selected to provide access to notes about the task 166, or through which a user can enter new notes for the task. Similarly, an icon 172 can provide access to documents (or allow a user to add new documents), an icon 174 can provide access to emails associated with the task 166 (or to add new emails or generate new emails related to the task), an icon 176 can provide access to files associated with the task (or add new files to associate with the task), and an icon 178 can provide access to records or other information associated with the task (or to associate new records or information with the task). The information in the callout 164 can include more, less, or different information than shown in FIG. 1. In addition, the information may be displayed in another manner, rather than in a callout.

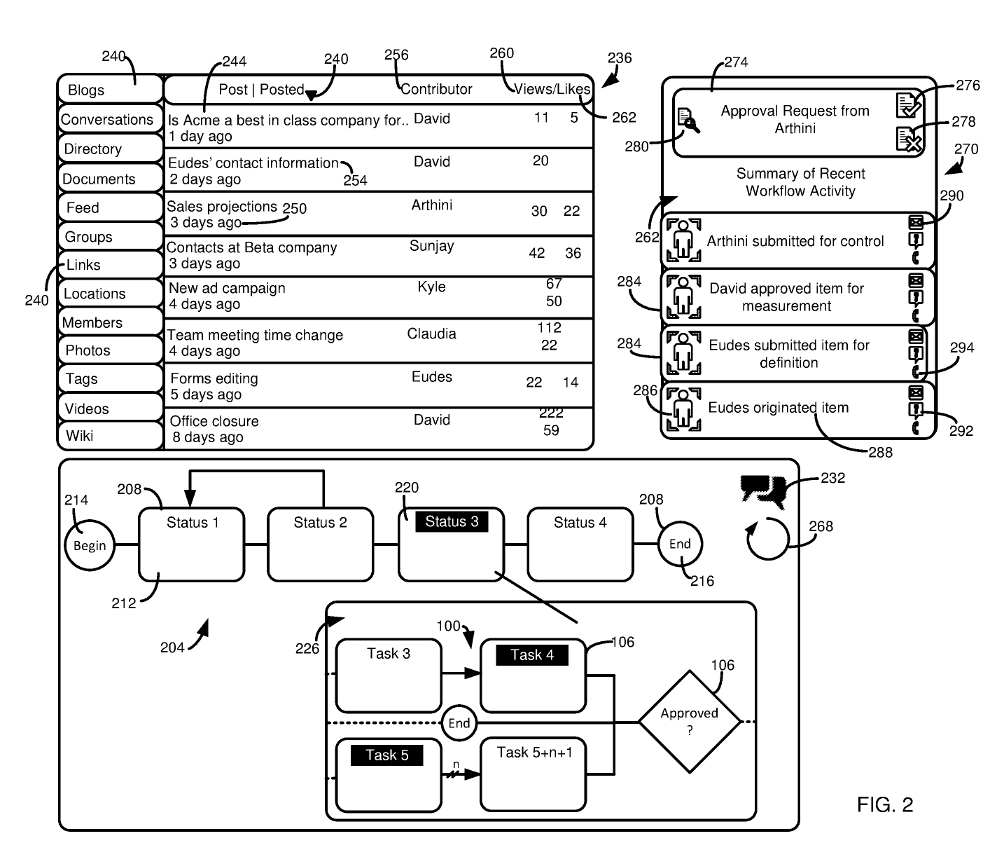

With reference to FIG. 2, as discussed above, a workflow can be simplified or abstracted as a status network, with various stages of the workflow being associated with different status designations. The status network can be displayed, such as to a user. For example, FIG. 2 illustrates a status network 204 corresponding to the workflow 100 of FIG. 1. The status network 204 includes status network components 208, such as four statuses 212, corresponding to statuses S₁-S₄ of the workflow 100, and begin and end blocks 214, 216.

In some cases, the status network 204 can be associated with a workflow that is being executed and can provide a visual indication of the status of the workflow. For example, a status 212 that contains the workflow component 106 associated with the current execution status of the workflow 100 can be highlighted. The status network 204 indicates that the workflow 100/status network is currently in Status 3, as shown in the highlighting of the status component 220.

Although the status network 204 is typically an abstraction or simplification of a workflow 100, in at least some aspects, the status network 204 can include process details. For example, the status network 204 illustrates status 2 in a loop with status 1 (not shown in the workflow 100 of FIG. 1). The loop can represent, in particular cases, an item being sent by a first user to a second user for approval, with the workflow 100/status network 204 returning to the first user after the second user approves or rejects the item.

The status network 204 can be configured to provide additional information. For instance, by selecting a particular status component 208, a user may be provided with additional details regarding the status component, such as more granular details regarding an underlying workflow. FIG. 2 illustrate status component 220 associated with status 3 as selected. Detail window 226 provides the workflow components 106 associated with status 3 of the workflow 100. If the detail window 226 displays the currently active status 212, the detail window can display the current workflow component(s) 106 as highlighted. For example, Task 4 and Task 5 are shown highlighted, indicating that the workflow 100 is currently in those particular steps.

A display of a status network 204 (and, in at least some aspects, a display of a workflow 100) can include options to provide additional information associated with the status network 204 or workflow 100. For example, by selecting a collaboration component icon 232, as user may be presented with information on a collaboration platform or social network relating to the status network 204 or workflow 100, such as in a display window 236 where a user can select from various services 240 of a collaboration component. As examples, services 240 can include, as associated with the status network 204/workflow 100, blog postings, conversations (such as a comment board), a directory of individuals, documents, information feeds or streams, groups, links (such as links to web pages or other resources), locations, members, photos, tags, videos, and wiki pages.

In particular, display window 236 presents various postings 244, such as conversation threads. The display window 236 can provide icons to search or navigate the information presented. For example, a sort icon 248 can allow a user to sort postings 244 according to particular criteria, such as by chronological posting date 250, or alphabetically by post title 254 or contributor 256. To help a user determine the potential relevance or usefulness of information presented in the display window 236, the display window 236 can present information regarding the popularity of the information, such as the number of times the information has been viewed by other users 260 or information about the number of “likes” or similar feedback 262 left by other users. In some cases, information having a higher number of views or likes can indicate information more likely to be of relevance to another user.

By selecting a history icon 268. a user can be presented with a display window 270 that presents information associated with the current execution status of a particular instance of the status network 204/workflow 100. For example, the display window 270 can provide a user with information regarding action items 274 requiring the user's attention. Action item 274 can represent a request for the user to approve, reject, or otherwise take action regarding information associated with the status network 204/workflow 100. The user can be provided with icons to approve 276, reject 278, or obtain more information 280 regarding the action item 274.

In addition to any current action items 274, the user can be presented with a display of prior activity in the status network 204/workflow 100. Each entry 284 relating to prior activity can include information regarding a user associated with the entry. The information regarding the user can include the user's name, an image 286, (such as a photograph) of, or associated with, the user, a description 288 of the prior activity, and contact information associated with the user, such as icons to email 290, text/message 292, or telephone 294 the user. In some examples, more information regarding a user (such as personal information associated with the user or documents or other content associated with the user) can be obtained by selecting (e.g., “clicking”) the image 286.

In other aspects, the displays 226, 236, 270 can present less, additional, or different information than shown. In addition, the information can be displayed in a manner other than as shown.

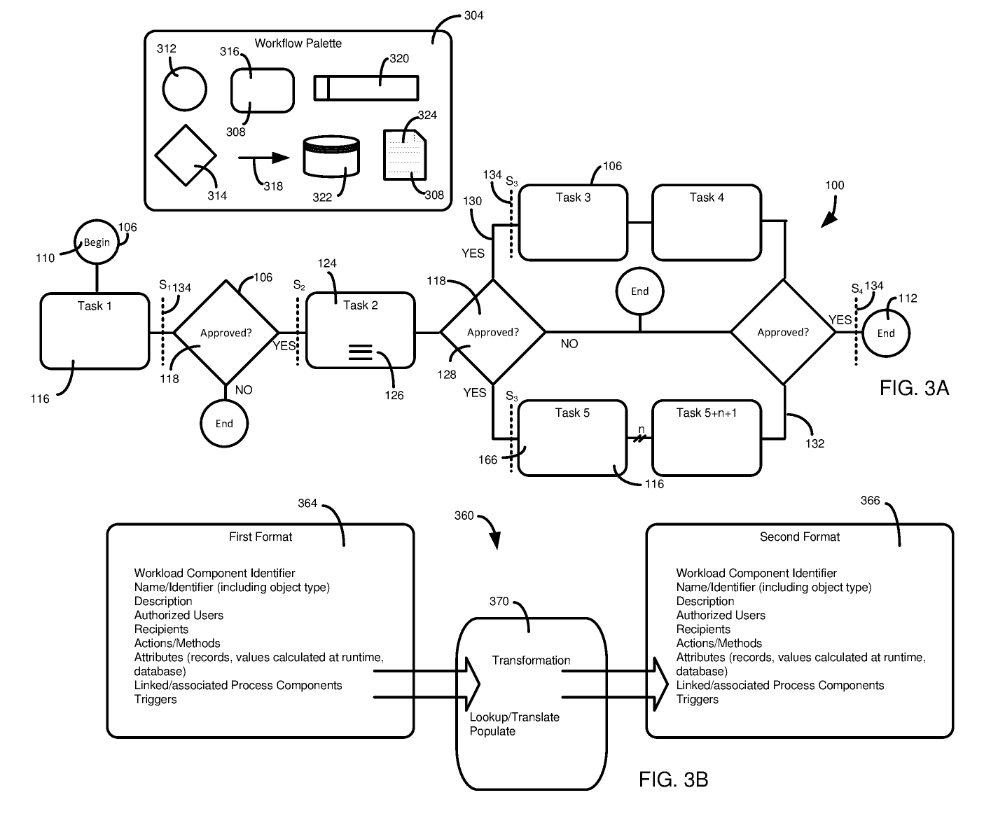

FIG. 3A illustrates how a workflow palette 304 can be used to build a process model specification, such as the workflow model specification 100 of FIG. 1. Components of the workflow model specification 100 are labeled as in FIG. 1. Although FIG. 3A is described in conjunction with a workflow model specification, FIG. 3A and its accompanying discussion apply more generally to process model specifications.

The workflow palette 304 can include icons 308 that a user may select to build or modify a workflow model specified in a graphical format. For example, the workflow palette 304 is shown as including an icon 312 for start/end components, an icon 314 for gateways, an icon 316 for tasks, an icon 318 for connections, an icon 320 for swim lanes, an icon 322 for data sources, and an icon 324 for documents. The workflow palette 304 can include more, fewer, or different icons. In addition, the workflow palette 304 can be displayed in other manners, such as in the form of a toolbar.

In at least some cases, a user may be able to configure components 106, such as components added from the workflow palette 304. For example, a callout 332 may provide options, such as in the form of dropdown menus or text entry fields, for a user to select or modify attributes of a particular component 106, such as task 124. For example, callout 332 may provide a field 334 to provide a name for the task 124. A field or dropdown menu 336 can be provided for a user to select data or other attributes to be associated with the task 124. A field or dropdown menu 338 can provide for actions or other methods to be associated with the task 124.

In at least some cases, certain actions, such as tasks, can be predefined, and the field 338 can allow a user to associate the actions with the task 124 (or other component 106). In other cases, the field 338 can provide a user with options to define or modify an action to be associated with the task 124. A field or dropdown menu 342 can allow a user to associate users with the task 124, such as users responsible for executing the task or users authorized to view the task. In some cases, the field 342 can link to a user directory, such as a user directory filtered by users who might be relevant to the workflow model 100. In some cases, the task 124 may be triggered by certain events. Such events can be selected through a trigger field or dropdown menu 346.

As discussed above, the present disclosure can provide for converting a process model specification, such as a workflow model specification, from a first format to a second format. In at least some examples, the first format may be a graphical representation of the specification that may facilitate easier and faster process model definition or modification, but which may not be useable by at least certain software components needed to execute or otherwise implement the process model. The second format can be a format used to execute or otherwise implement the process model.

FIG. 3B schematically represents a process 360 for converting a process model specification, such as a workflow model specification (for instance, the workflow model 100), between a first format 364 and a second format 366. Although FIG. 3B is described in conjunction with a workflow model, FIG. 3B and the accompanying discussion apply more generally to process models.

The first and second formats 364, 366 can include various properties that can be used to identify workflow model components 106, link the workflow model components to other workflow model components (e.g., linking a task to a predicate approval), associate users with the workflow model component and define their roles or permissions, associate data or other attributes with the workflow model component, or define methods or functions to be carried out in connection with the workflow model component.

The process 360 can represent information for a particular workflow model component 106 being transformed from the first format 364 to the second format 366 using a transformation process 370 (such as implemented by a software module or component). In some cases, the transformation process 370 can be carried out on a workflow model component by workflow model component basis, such as stepwise for processing of the entire workflow model specification 100, or as each workflow model component 106 is added, removed, or modified. In other cases, data for the entire workflow model specification 100 (or a portion thereof, but more than a single workflow model component 106) can be processed collectively.

As shown, the first and second formats 364, 366 include information regarding a workflow model component identifier. The workflow model component identifier can, for example, indicate a particular type or class of workflow model component. For example, one workflow model component identifier can represent a task, while another identifier can indicate a gateway. In at least some cases, the workflow model component identifiers differ between the first and second formats 364, 366, and the transformation process converts the workflow model component identifier of the first format into a corresponding identifier of the second format.

Each workflow model component 106 may be associated with additional identifiers, such as a name or other identifier (such as a unique numerical identifier). The workflow model components 106 may also be associated with a description (such as a textual description of the nature of the workflow model component, such as an overview of a task). In some cases, names and numerical identifiers may be taken from the first format 364 and populated in corresponding fields of the second format 366.

Workflow model components 106 may have additional properties, such as users authorized to access the workflow model component, recipients of notifications associated with the workflow model component, users having approval over the workflow model component, users responsible for taking action regarding the workflow model component, actions and methods associated with the workflow model component, attributes (such as data, including records, values (including runtime calculated values), or database records or tables) associated with the components, workflow model components linked or otherwise associated with the particular workflow model component, and any triggers that may cause a particular workflow model component to become active.

One or more of these properties may differ between the first and second formats 364, 366. During the transformation process 370, the relevant property of the first format 364 can be converted to a form useable in the second format 366. For example, the process model specification can be converted from a graphical representation to a computer-executable representation. In a specific example, the first format is a modeling language, protocol, or format, such as UML or BPMN (which, in turn, may be implemented in a computing language, such as a programming language, a markup language, or a combination thereof) and the second format is a computing language, such as a programming language, such as ABAP, a markup language, or a combination thereof.

In some cases, all of the properties of the first format 364 are transformed into the second format 366. In other cases, less than all of the properties of the first format 364 are transformed (or otherwise represented) in the second format 366, or the second format includes properties that have no equivalent in the first format. In some implementations where a property has no equivalent in one of the formats 364, 366, the property can be omitted from the transformation 370. In other implementations, the transformation process 370 can attempt to reconcile the formats 364, 366, such as by supplying a default value, a value specified by rules, or a value specified by user input (such as, for example, user input received after prompting the user to provide a value).

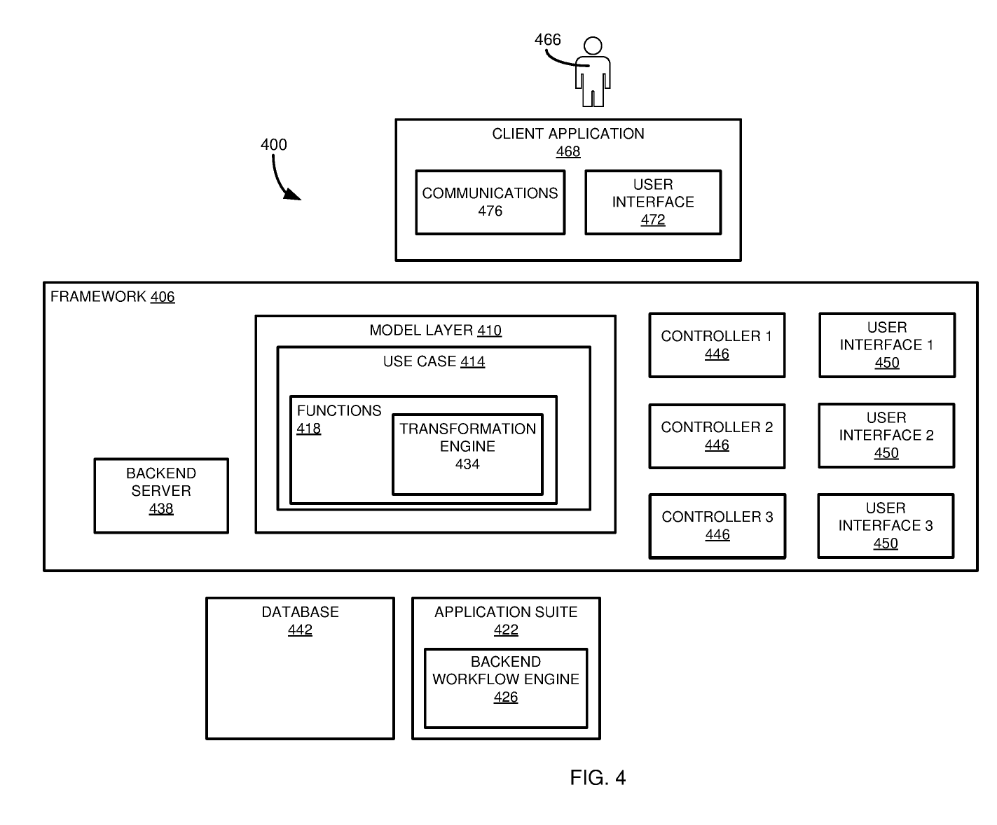

FIG. 4 is a block diagram providing an example software architecture 400 that can be used in implementing at least certain embodiments of the present disclosure. The software architecture 400 includes a framework 406 (for example, the NETWEAVER framework of SAP SE of Walldorf, Germany) The framework 406 can include a model layer 410. The model layer 410 can include software defining a plurality of tools a user can use to create, edit, and access process models, such as in a graphical representation of a process model specification. For example, the model layer 410 can provide process modeling tools, including defining selectable objects (e.g., icons, such as in the workflow palette 304 of FIG. 3) related to various aspects of a process model, such as a workflow model. In at least some cases, the model layer 410 can utilize the Unified Modeling Language (UML) or Business Process Model and Notation (BPMN).

The model layer 410 can include one or more use cases 414. The use cases 414 can be particular configurations of elements (e.g., process model components) provided by the model layer 410, including the elements, their interrelation, and their customizations (such as specifically assigned attributes, including associations with particular data elements). The use cases 414 can be associated with one or more functions 418. The functions 418 can, for example, be responsible for carrying out various operations associated with, or specified by, the use cases 414.

In addition, in at least some examples, the functions 418 can transform use cases 414 into other formats. For example, an application suite 422 (for example, the SAP BUSINESS SUITE application suite of SAP SE of Walldorf, Germany) can include a backend workflow engine 426 (for example, the WORKFLOW BUILDER engine of SAP SE of Walldorf, Germany). The backend workflow engine 426 can be responsible for defining and executing a workflow model specification, including by using applications of the application suite 422, components of the framework 406, or a client application 468 (for example, the FIORI application of SAP SE of Walldorf, Germany). The conversion or transformation of the use cases 414 can be carried out by a transformation engine 434.

The transformation engine 434 can, for example, generate scripts or commands that can be forwarded to other components, such as to the backend workflow engine 426 or other components of the application suite 422. In one example, elements of the model layer 410 (such as individual modeling elements, for example, elements representing various components of a workflow model), can be associated with scripts or commands. As a use case 414 is constructed using the elements, the corresponding scripts or commands can be generated, and, when appropriate, such as for execution, forwarded to the backend workflow engine 426 or other components of the architecture 400. In some cases, an entire workflow model specification is transformed using the transformation engine 434 to create a specification that is implemented in the backend workflow engine 426 (and, optionally, other components). In other cases, the transformation engine 434 can transform individual workflow model specification components to a format executable by the backend workflow engine 426 (and, optionally, other components), as each component is selected for implementation.

The model layer 410 can be in communication with a backend server 438. The backend server 438 can mediate communications between the framework 406 and its components and other components of the architecture 400. For example, the backend server 438 can mediate communications with the application suite 422 or a database 442 (for example, the HANA database system of SAP SE of Walldorf, Germany). The database 442 can store data useable by the functions 418, or otherwise associated with the use cases 414.

The model layer 410 can be in communication with one or more controllers 446. Each controller 446 can be associated with a user interface 450 (that is, the framework 406 can implement a user interface using a model-view-controller architectural pattern). The user interface 450 can provide views to a user, and accept user input. The user input can be sent by the user interface 450 to the controller 446. The controller 446 can convert the user input into commands to interact with the model layer 410. Although shown as separate, the controllers 446 or the user interfaces 450 can be implemented in common software components.

A user 466 can interact with the framework 406, and its components, through a client application 468 (for example, the FIORI application of SAP SE of Walldorf, Germany) The client application 468 can include a user interface 472, such as to receive user input and generate displays for the user 466. The client application 468 can also include, or be in communication with, a communication module 476. The communication module 476, can, in some examples, communicate with user interfaces 450 of the framework 406, such as using the http protocol.

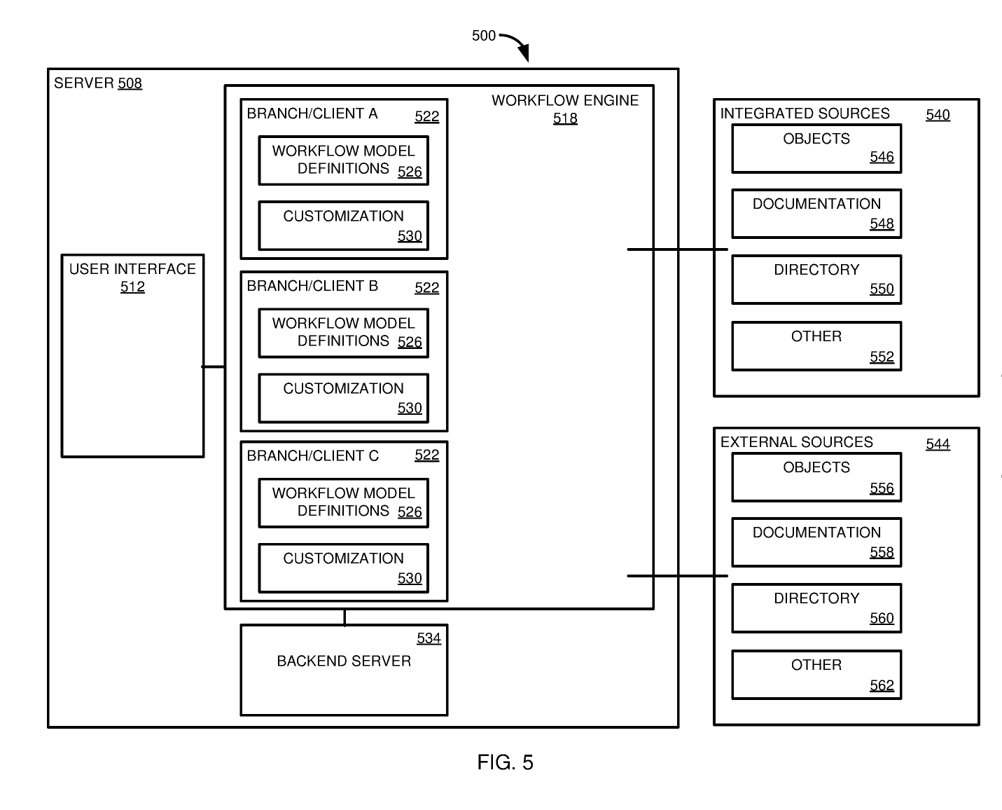

FIG. 5 is a block diagram providing an example software architecture 500 that can be used in implementing at least certain embodiments of the present disclosure. The architecture 500 includes a server 508. In at least some implementations, the server 508 can be an ABAP server. The server 508 can include a user interface 512 (for example, the FIORI application of SAP SE of Walldorf, Germany) The user interface 512 can be, at least in some examples, the user interface 450 of FIG. 4.

The architecture 500 can include a workflow engine 518 (which can be, more generally, a process engine). The workflow engine 518 can include client workflow model configuration information 522 for one or more clients, which can include base workflow (or process) definitions 526 and customization information 530. The base workflow definitions 526 can include workflows that have been defined for all, or a portion, of one or more clients.

Each client can be associated with customization information 530. The customization information 530 can, for example, add or modify (including, in at least some cases, deleting) functionality of the base workflow model definitions 526. In some examples, the workflow engine 518 can be part of the model layer 410 of FIG. 4, such as being included in the functions 418 or the transformation engine 434.

The architecture 500 illustrates configuration information 522 for three clients, A, B, and C. However, architecture 500 can include configuration information 500 for more or fewer clients, including for a single client. In some implementations, the configuration information 522 is not segregated by clients. In yet further implementations, the architecture 500 need not provide customization information 530.

The workflow engine 518 can communicate with a backend server 534 (which can include, or provide an interface with, for example, the SAP BUSINESS SUITE application suite of SAP SE of Walldorf, Germany), which can, in at least some cases, be the backend server 438 of FIG. 4. The backend server 534 can assist in sending or receiving information between the workflow engine 518 and other software components, including a database (e.g., the database 442 of FIG. 4) or additional applications (e.g., the application suite 422).

The workflow engine 518 can be in communication with other sources of information, including integrated information sources 540 (for example, the SAP JAM collaboration component of SAP SE of Walldorf, Germany) and external information sources 544. The integrated information sources 540 can include information available within an integrated set of software components, which can include one or more of the client application 468, the framework 406, the database 442, and the application suite 422 of FIG. 4, as well as one or more components of the server 508, such as the workflow engine 518 or the backend server 534.

The integrated information sources 540 can include objects 546. Objects 546 can include records (such as business records, which can include data, as well as collections of data, formatted data, etc.). The integrated information sources 540 can also include documentation 548, such as notes, files, or other documents related to a particular workflow model or workflow model component.

The integrated information sources 540 can also include a directory 550. The directory 550 may provide, for example, a list of users relevant to a workflow, such as those responsible for processing or approving different steps in the workflow. The directory 550 can provide information relating to such users, including biographical information, information regarding the users' relevance to the workflow, and contact information for the users, such as phone or email contact information. In at least some cases, the directory 550 can allow a user to be contacted through a messaging service forming part of the integrated information sources 540. The integrated information sources 540 can include other information sources 552.

The workflow engine 518 can also be in communication with external information sources 544. The external information sources 544 can include external objects 556, such as records, and documentation 558. The external information sources 544 can also include a directory 560, which can provide access to information regarding users relevant to a particular workflow. The external information sources and include other information sources 562.

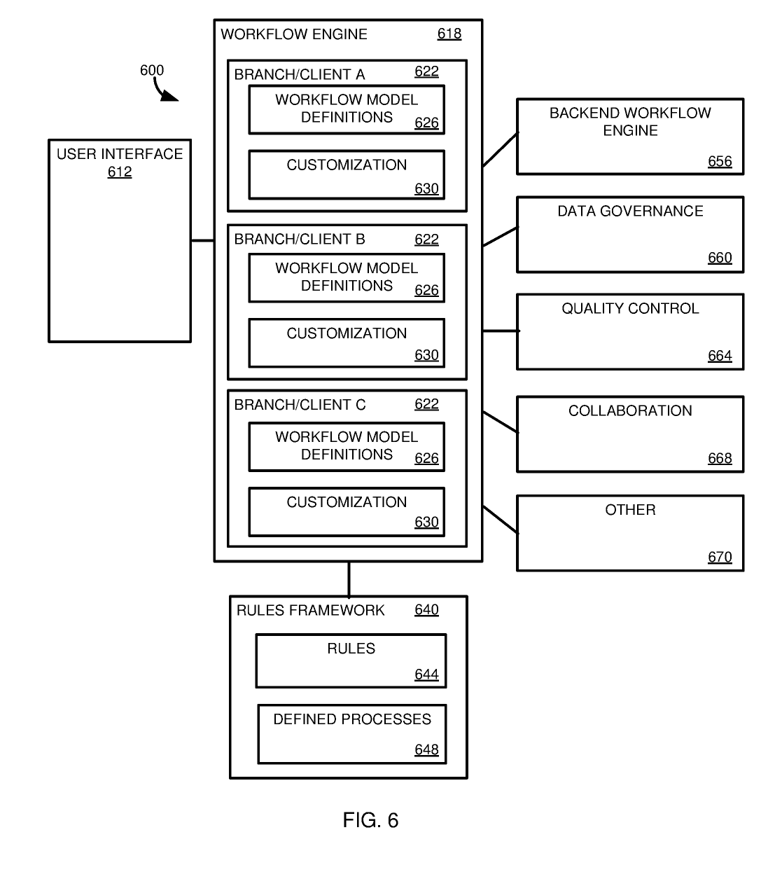

FIG. 6 is a block diagram providing an example software architecture 600 that includes a workflow engine 618 (which can be, more generally, a process engine, for example, the WORKFLOW BUILDER engine of SAP SE of Walldorf, Germany), which can include configuration information 622 for one or more clients. The configuration information 622 can be configured analogously to the configuration information 522 of FIG. 5, such as including base workflow definitions 626 and customization 630, which may be configured at least analogously to the corresponding components of FIG. 5. Likewise, architecture 600 can include a user interface 612 (for example, the FIORI application of SAP SE of Walldorf, Germany), which can be configured analogously to the user interface 512 of FIG. 5.

The workflow engine 618 is in communication with a rules framework 640 (for example, the BUSINESS RULES MANAGEMENT framework of SAP SE of Walldorf, Germany). The rules framework 640 can include rules 644. Rules 644 can define one or more elements of a workflow model, including how the elements should be processed. In at least some cases, the rules 644 can define processes for executing a step in a workflow model specification. For example, a particular workflow model element may represent a particular stage of a process, such as a stage carried out by a particular user. That particular stage may itself include a subprocess the user should follow in carrying out the workflow model element. The rules 644 can define that process.

The rules framework 640 can also include defined processes 648. Defined processes 648 can include defined ways, such as predefined workflow models, for carrying out an activity. In some cases, the defined processes 648 can represent a workflow model template that can be modified by a particular user, or for a particular client. For example, customization information 630 of the workflow engine 618 can specify how a defined process 648 should be modified for a particular client. A workflow model for a client, including a workflow model based on a defined process 648, can include one or more rules 644 for accomplishing particular steps or tasks of a workflow model element.

The workflow engine 618 can be in communication with a backend workflow engine 656, which, in at least some cases, can be configured at least analogously to the backend workflow engine 426 of FIG. 4. The backend workflow engine 656 can be responsible for the execution (or implementation) of a workflow model specification defined using the workflow engine 618.

The workflow engine 618 can also be in communication with a data governance component 660. The data governance component 660 (for example, the MASTER DATA GOVERNANCE application of SAP SE of Walldorf, Germany) can be responsible for providing data access to the workflow engine 618, including providing information used to execute workflow model items, and integrating data created during workflow model specification execution. For example, data created or modified during workflow execution can be merged with a data repository, which can represent a central repository accessible to multiple users. When multiple users have access to data, data inconsistencies can arise. The data governance component can be responsible for actions such as reconciling inconsistencies, or determining which of different data versions should be used for the central repository.

The workflow engine 618 can be in communication with a quality control component 664 (for example, the QUALITY ISSUE MANAGEMENT application of SAP SE of Walldorf, Germany). The quality control component 664 can monitor implementation of a workflow model specification to determine if events in the implementation raise quality control issues. If the workflow model implementation creates potential quality control issues, the quality control component 664 can take appropriate action, such as notifying a user of a potential issue. The quality control component 664 can also collect information relevant to quality control analysis, or relevant to addressing potential quality control issues.

A collaboration component 668 (for example, the SAP JAM collaboration platform of SAP SE of Walldorf, Germany) can be in communication with the workflow engine 618. The collaboration component 668 can facilitate collaboration and interaction between users involved in a particular workflow model. For example, the collaboration component 668 can facilitate communication between users, such as by providing users with tools to share information, and otherwise communicate, with other users involved in a workflow model. The collaboration component 668 can also provide notifications to users regarding activities associated with a workflow model. For example, the workflow engine 618, through the collaboration component 668, can notify a user when they need to take action regarding a workflow model component, or regarding the status of a workflow model component, such as when a particular workflow model component has been completed or, in at least some cases, has not been completed. The workflow engine 618 can be in communication with other components 670.

In some cases the workflow engine 618 need not be in communication with one or all of the backend workflow engine 656, the data governance component 660, the quality control component 664, or the collaboration component 668. Although the components 656, 660, 664, 668 are shown as separate, in at least some cases, the functionality of at least certain of the components can be combined, or the functionality of the components otherwise distributed in a different manner.

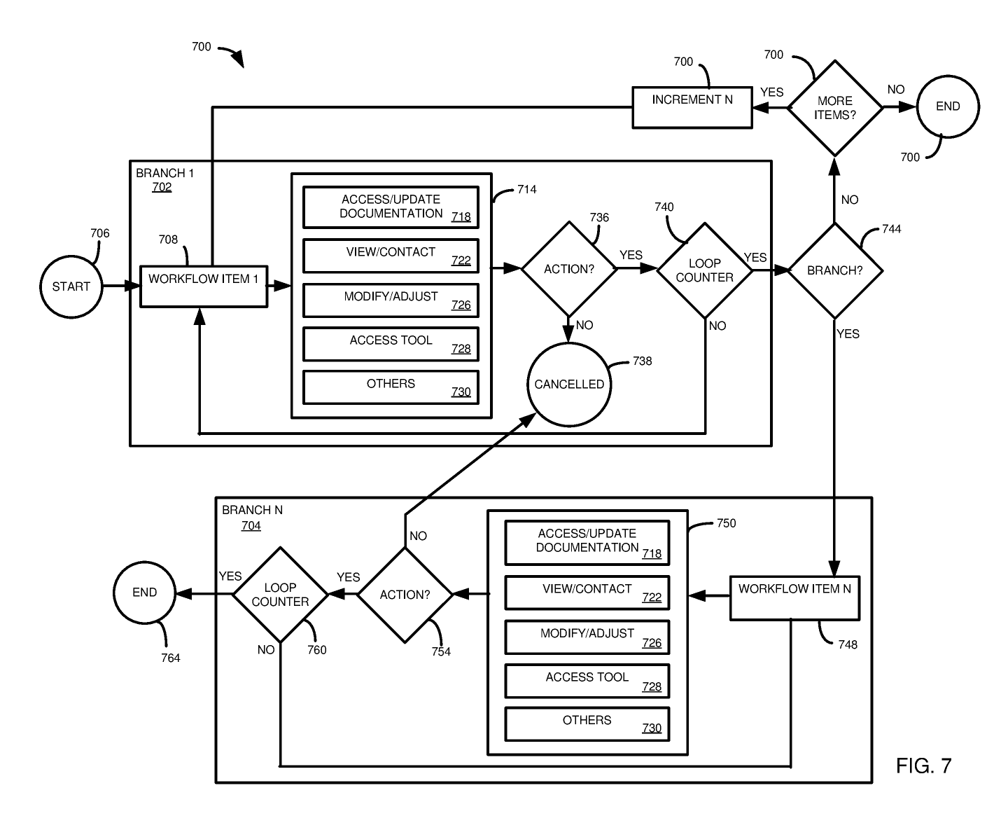

FIGS. 7-10 illustrate various processes that can be used to create or implement a process model specification, such as a workflow model specification. The processes are generally described with respect to implementation of the model specification. Processes to create the model specification are processes which create a model specification having the described functionality.

FIG. 7 illustrates a process 700 that may be used to define a workflow model specification (more generally, a process model specification), such as using the user interface 450 and model layer 410 of FIG. 4. For example, the workflow model specification may be defined using the workflow model palette 304 of FIG. 3A. The process 700 may also be used to implement a workflow model specification (for example, as shown in FIG. 1), such as using the user interface 450, the controller 446, the model layer 410, and the backend workflow engine 426.

The method 700 can include two or more branches 702, 704. Branches 702, 704 can represent subprocesses of a primary workflow model path. For example, branches 702, 704 can have previously forked from a primary workflow model path. Branches 702, 704 can join, or rejoin, a primary workflow model path. In some cases, braches 702, 704 can be independent. In other cases, branches 702, 704 can be interrelated. Although not shown, one or both of branches 702, 704 can themselves include one or more branches. Although two branches 702, 704 are shown, a particular workflow model can include more than two branches from a particular process. Branches can be used to represent subprocesses or workflow model components that require multiple approval such as a 4-eyes process.

The method 700 begins at step 706, which may represent, for example, a communication from a user, such as to add or execute a workflow model specification or a workflow model component. In step 708, the user selects, such as for definition or execution, a first model workflow item. The first workflow model item can include one or more actions 714, such as to access or update documentation (such as file notes, for example, using the SAP JAM collaboration platform of SAP SE of Walldorf, Germany) 718, view or contact a user or other individual 722, to modify or adjust data 726 associated with the first workflow model item, to access an external software component (such as a communications program or a document management or collaboration system, such LYNC or SHAREPOINT of MICROSOFT, CORP., of Redmond, Wash.) 728, or other actions 730.

Decision 736 determines whether a user has taken action regarding the first workflow model item. For example, the user may be an authorizing user whose approval is required to complete the first workflow model item, or otherwise progress the workflow model. In some cases, the authorizing user can reject the first workflow model item. When the first workflow model item is rejected, in a particular example, the process 700 can terminate at step 738. In other examples, when the first workflow item is rejected, the process 700 can proceed to another step or action. For instance, the process 700 can return to step 708, where the user can take additional actions 714.

In some cases, a workflow model item may need to be carried out multiple times before it can be completed. In such cases, after the authorizing user has approved the first workflow model item in decision 736, the process 700 can process to decision 740, a loop counter for the first workflow model item. Decision 740 can determine whether a counter value has been met for the first workflow model item. If the counter value has not been met, the counter value can be incremented, and the process 700 may return to an earlier step, such as step 708, where the user can take additional actions 714.

If decision 740 determines that a counter value has been met, the method 700 can proceed to decision 744, where the method determines whether the workflow model contains a branch. If the workflow model contains a branch, the process 700 can proceed to step 748, where branch 704 for the workflow model is executed. Step 748 can include selecting one or more actions 750 to be taken. The actions 750, in at least some cases, can be at least analogous to the actions 714. In other cases, the actions 750 can include more, fewer, or different actions than the actions 714.

Decision 754 determines whether a user has taken action regarding the workflow model item. The user can be an authorizing user, which can be the same user or a different user than the authorizing user associated with decision 736. In at least some implementations, if the authorizing user rejects the workflow model item in decision 754, the workflow model, or one or more individual workflow model items, can terminate, such as at step 738 (that is, the branches 702, 704 are interrelated such that termination of the process of branch 704 also terminates the process of branch 702). In other cases, if the authorized user rejects the workflow model item in decision 754, a user may modify or adjust actions regarding the workflow model item (e.g., the process 700 can return to step 748 or step 708).

If the authorizing user approves the workflow item in decision 754, the method 700 can proceed to decision 760, a loop counter for the workflow model item. Decision 760 can determine whether a counter value has been met for the workflow model item. If the counter value has not been met, the counter value can be incremented, and the process 700 may return to an earlier step, such as step 748, where the user can take additional actions 750. In some aspects, if decision 760 determines that the loop counter value has been met, the method 700 can end at step 764. In some cases, ending the method in step 764 can include rejoining a primary process.

Although process 700 shows the determination of whether a branch exists after the decision 740, the process may be carried out differently. For example, the process 700 can determine whether a branch exists before, or concurrently with, carrying out step 708. In this way, more workflow model components of the workflow model specification may be carried out concurrently.

Approval by authorizing users may also be handled in a different manner That is, in some cases, all authorizing users associated with a branched workflow model must approve of their respective workflow model items (e.g., decisions 736 and 754) before the workflow model can advance to the next workflow model item. In other cases, the workflow model can proceed if at least one authorizing user approves of their respective workflow model item.

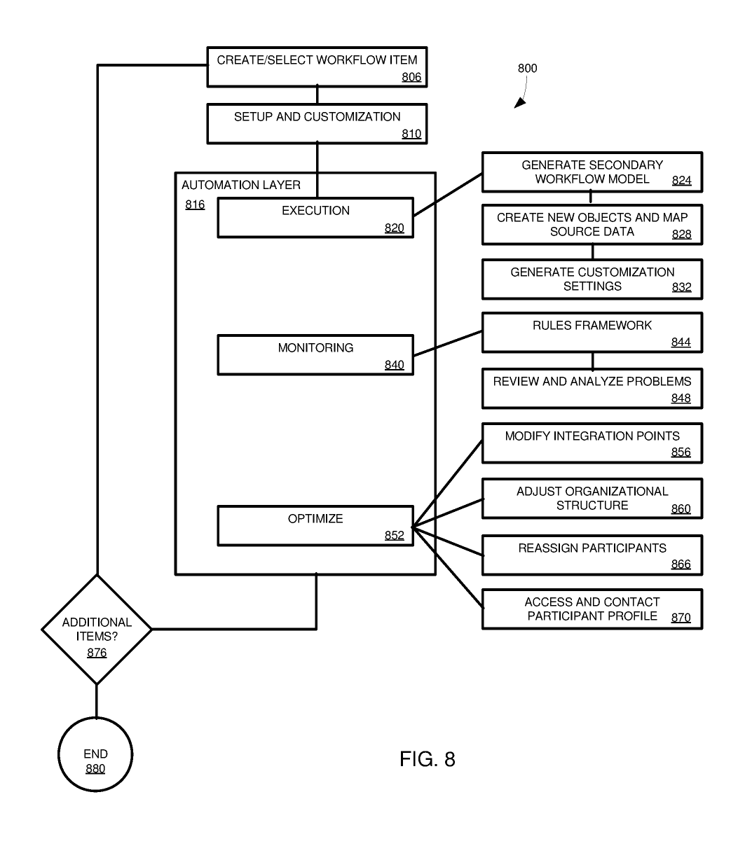

FIG. 8 illustrates a process 800 for creating or executing a workflow model specification, including transforming a workflow model specification from a first format to a second format. In step 806, a user selects or creates a workflow model item. In particular implementations, the user creates or selects the workflow model item using a modeling tool, such as a BPMN or UML software module. For example, the user may use the workflow model palette 304 of FIG. 3A.

In step 810, the user can set up or customize the workflow model item, including defining activities or tasks associated with the workflow model item and, optionally, one or more authorizing users to approve the workflow model item. For example, the user may take action using the callouts 138, 164 of FIG. 1.

After the workflow model item has been defined, an automation layer 816 can carry out one or more steps of the process 800. For example, the automation layer 816 may execute the workflow model item in step 820. In executing the workflow model item in step 820, the automation layer 816 may generate a workflow model specification in a second format in step 824 (e.g., using the process 360 of FIG. 3B). For example, the process 800 may generate a workflow model specification useable by the backend workflow engine 126 of FIG. 1. In a specific case, for each component of the workflow modelled using a modeling tool, the process 800 can generate suitable commands to create or define the workflow model item in a second format. In a particular example, step 824 transforms at least a portion of the components of the workflow model item from a graphical (e.g., BPMN) representation to an executable representation in a computing language, such as ABAP.

Once the workflow model specification in the second format has been created, objects (such as business records) used in the workflow model item can be associated with the workflow model item or created in step 828. Source data associated with the objects can be mapped to the object. In step 832, any customized settings associated with the workflow model item can be created.

In step 840, the automation layer 816 can carry out monitoring functions. When the workflow model item is being executed, step 840 can include comparing actions and activities carried out with respect to the workflow model item with associated rules of a rules framework 844. In at least some implementations, step 840 can include monitoring the workflow model item for potential quality control issues, or issues regarding data integrity. If a potential quality control or data integrity issue is identified, the issue can be reviewed and analyzed in step 848.

The automation layer 816 can provide for optimization in step 852. For example, integration points, such as between various data sources and software components associated with the workflow model specification, can be adjusted in step 856. In step 860, an organizational structure, such as of users relevant to the workflow model, can be adjusted. For example, modification of an organizational structure may affect which users are responsible for carrying out various workflow model items, as well as which users are the authorizing users for particular workflow model items.

Users associated with the workflow model may be reassigned in step 866. For example, users having access to the workflow model, being responsible for particular workflow model items, or being authorizing users for particular workflow model items can be reassigned. In step 870, information associated with users relevant to the workflow model item can be accessed, and, in at least some cases, the relevant user contacted, such as by phone, email, or using a messaging service.

After any steps associated with the automation layer 816 have been completed, the process 800 can proceed to decision 876 to determine whether any additional workflow model items are to be created or executed. If no additional workflow model items are to be created or executed, the process 800 can end at step 880. If additional workflow model items are to be created or executed, the process 800 can return to step 806.

In some aspects, the process 800 may be carried out in a different manner than illustrated in FIG. 8. For example, in some cases, when the process 800 is carried out to define a workflow model specification having a plurality of workflow model items, steps 806 and 810 can be carried out for each workflow model item prior to the execution of at least certain steps associated with the automation layer 816.

In a particular example, the workflow model items are created in steps 806 and 810, and the complete workflow model specification is processed in step 824 to generate the workflow model specification in the second format. In at least some cases, one or more workflow model items can subsequently be added, deleted, or modified, which may be carried out as shown in FIG. 8 (e.g., the workflow model specification in the second format being updated one workflow model item at a time), or multiple workflow model items may be updated and then the workflow model specification in the second format adjusted in step 824.

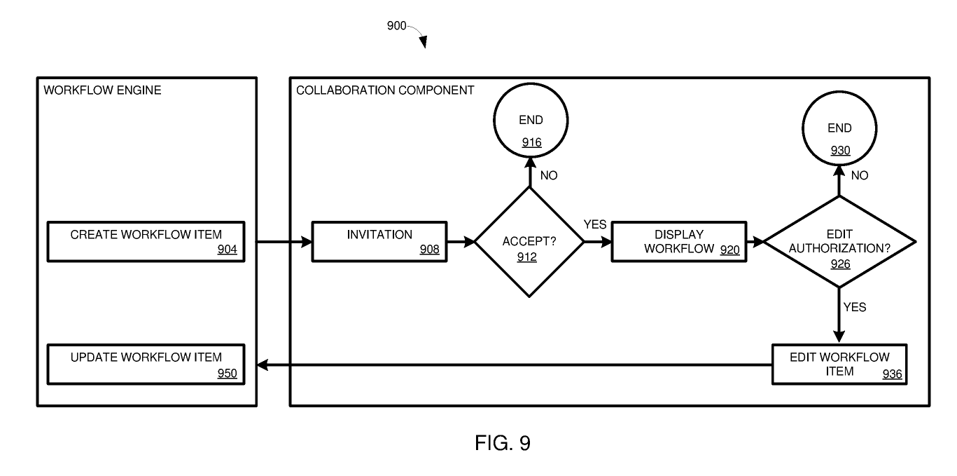

In at least some cases, a workflow model, or workflow model items, of the present disclosure can be associated with a collaboration tool or communication information regarding users relevant to the workflow model (for example, using the SAP JAM collaboration platform of SAP SE of Walldorf, Germany). The collaboration tool or communication information can be used to provide users with information relevant to the workflow model, including, at least in some cases, notifications relating to workflow model items. FIG. 9 illustrates a method 900 that can be used to associate a user with a workflow model item or to contact a user during execution of the workflow model item.

In step 904, a workflow model item is created, such as by a first user. In step 908, an invitation or notification is sent to a second user to be associated with the workflow model item (for example, using the SAP JAM collaboration platform of SAP SE of Walldorf, Germany). In optional decision 912, the second user can choose whether to accept the initiation or otherwise be associated with the workflow model.

If the second user rejects the invitation in decision 912, the process 900 can end in step 916. In some cases, rather than the process 900 ending if the second user rejects the invitation, the process can return to another step. For example, the process can return to step 904 where the user can modify the workflow model item, including associating the workflow model item with a different second user, or modifying the workflow model item and resending the workflow model item to the second user in step 908. In at least some cases, decision 912 is omitted, and the second user is associated with the workflow model item when it is created by the first user in step 904.

If the second user accepts the invitation in decision 912, or if decision 912 is omitted, workflow information, including information relevant to the workflow model item, can be displayed to the second user in step 920. In at least certain implementations, the second user may be given permission to edit the workflow model, or a particular workflow model item. In decision 926, the method 900 checks to see whether the second user is authorized to edit the workflow model or workflow model item, such as in response to action by the second user to modify the workflow model or workflow model item. If the second user is not authorized to modify the workflow model or workflow model item, the process 900 can end in step 930. If the second user is authorized to modify the workflow model or workflow model item, the second user can edit the workflow model or workflow model item in step 936, which is then updated in the workflow engine in step 950.

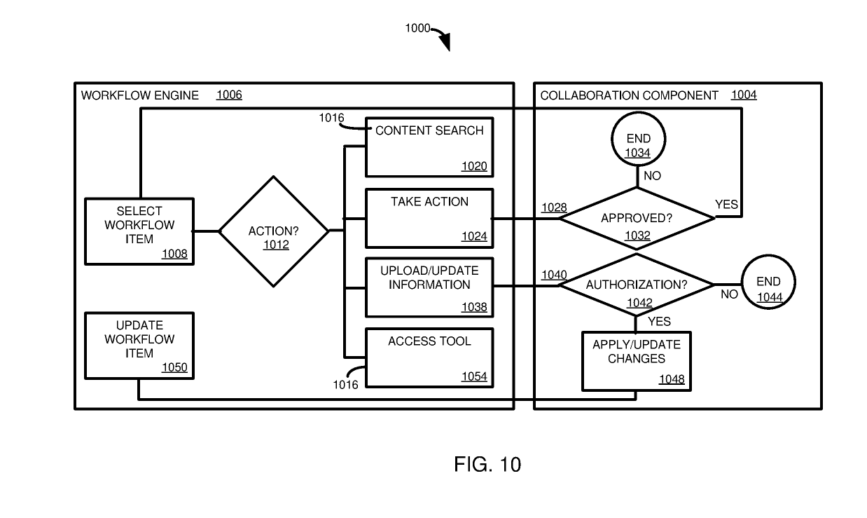

FIG. 10 depicts a method 1000 where a collaboration component 1004 (for example, the SAP JAM collaboration platform of SAP SE of Walldorf, Germany) in communication with a workflow engine 1006 can be used by an authorizing user to approve a workflow model item. In step 1008, a workflow model item is selected by a first user. In decision 1012, the first user may elect to take one or more actions 1016 regarding the workflow model item. For example, in step 1020, the first user may search for content related to the workflow model item, such as business records or notes created by the first user or another user.

In step 1024, the first user may request that a second user take action with respect to the workflow model item, such as to approve or reject the workflow model item. The request to take action can be sent by the workflow engine 1006 to the collaboration component 1004 in communication 1028. In decision 1032, the second user can determine whether to take action, such as to approve or reject, regarding the workflow model item.

If the second user does not approve the workflow model item, the workflow model can end in step 1034. However, in other cases, when the second user does not approve the workflow model item, the method 1000 can continue at another step. For example, the method 1000 can return to decision 1012, where the first user can take additional actions regarding the workflow model item. If the workflow model item is approved, the method 1000 can return to step 1008, where a user can select another workflow model item (assuming the workflow model specification contains additional workflow model items).

In step 1038, the first user may elect to update information, such as business records, notes, or other documents, associated with the workflow model item, or to upload information to be associated with the workflow model item. The request to update or upload information may be sent from the workflow engine 1006 to the collaboration component 1004 in communication 1040.

In decision 1042, the collaboration component 1004 can determine whether the first user is allowed to edit information associated with the workflow model item. If the first user is not so authorized, the method 1000 can end in step 1044. In other cases, rather than ending in step 1044, the method 1000 can return to another step. For example, the method 1000 can return to decision 1012 where the first user can take other actions regarding the workflow model item. If decision 1042 determines that the first user is authorized to edit information associated with the workflow model item, the workflow model item can be updated in step 1048. The updates can be sent to the workflow engine 1006 to be updated in step 1050.

Returning to decision 1016, as another action, the first user may select an access tool in step 1054, such as a tool to access a communications program (such as an email, messaging, or telephonic communication program), or a content sharing application, such as a shared document repository (such as a communications program or a document management or collaboration system, such LYNC or SHAREPOINT of MICROSOFT, CORP., of Redmond, Wash., or the SAP DOCUMENT CENTER application of SAP SE of Walldorf, Germany).

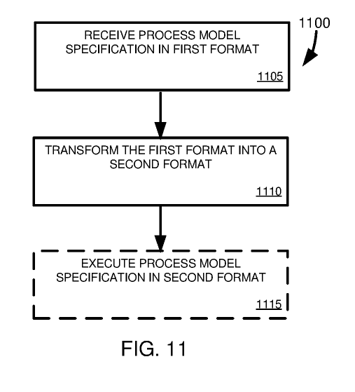

FIG. 11 illustrates a flowchart of a method 1100 according to an embodiment of the present disclosure for transforming a process model specification from a first format, such as a graphical representation of a process, to a second format, such as a format that allows the process model to be executed or implemented. In step 1105, a specification of a process model is received in a first format. In step 1110, the first format is transformed into a second format. In optional step 1115, the specification of the process model is executed in the second format.

### Example 3—Computing Systems

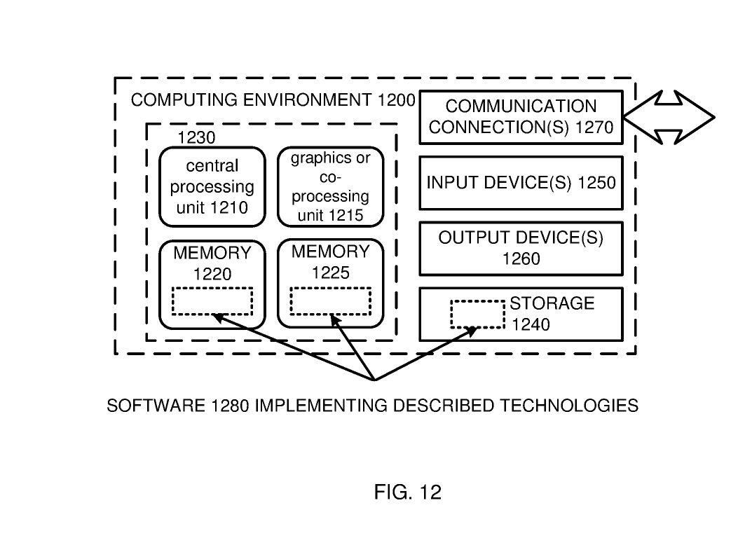

FIG. 12 depicts a generalized example of a suitable computing system 1200 in which the described innovations may be implemented. The computing system 1200 is not intended to suggest any limitation as to scope of use or functionality of the present disclosure, as the innovations may be implemented in diverse general-purpose or special-purpose computing systems.

With reference to FIG. 12, the computing system 1200 includes one or more processing units 1210, 1215 and memory 1220, 1225. In FIG. 12, this basic configuration 1230 is included within a dashed line. The processing units 1210, 1215 execute computer-executable instructions, such as for implementing a computing environment, and associated methods, described in Examples 1 and 2. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 12 shows a central processing unit 1210 as well as a graphics processing unit or co-processing unit 1215. The tangible memory 1220, 1225 may be volatile memory (e.g., registers, cache, RAM), non-volatile memory (e.g., ROM, EEPROM, flash memory, etc.), or some combination of the two, accessible by the processing unit(s) 1210, 1215. The memory 1220, 1225 stores software 1280 implementing one or more innovations described herein, in the form of computer-executable instructions suitable for execution by the processing unit(s) 1210, 1215. The memory 1220, 1225, may also store database data, such as data associated with the database 442 of FIG. 4.

A computing system 1200 may have additional features. For example, the computing system 1200 includes storage 1240, one or more input devices 1250, one or more output devices 1260, and one or more communication connections 1270. An interconnection mechanism (not shown) such as a bus, controller, or network interconnects the components of the computing system 1200. Typically, operating system software (not shown) provides an operating environment for other software executing in the computing system 1200, and coordinates activities of the components of the computing system 1200.

The tangible storage 1240 may be removable or non-removable, and includes magnetic disks, magnetic tapes or cassettes, CD-ROMs, DVDs, or any other medium which can be used to store information in a non-transitory way and which can be accessed within the computing system 1200. The storage 1240 stores instructions for the software 1280 implementing one or more innovations described herein.

The input device(s) 1250 may be a touch input device such as a keyboard, mouse, pen, or trackball, a voice input device, a scanning device, or another device that provides input to the computing system 1200. The output device(s) 1260 may be a display, printer, speaker, CD-writer, or another device that provides output from the computing system 1200.

The communication connection(s) 1270 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules may be combined or split between program modules as desired in various embodiments. Computer-executable instructions for program modules may be executed within a local or distributed computing system.

The terms “system” and “device” are used interchangeably herein. Unless the context clearly indicates otherwise, neither term implies any limitation on a type of computing system or computing device. In general, a computing system or computing device can be local or distributed, and can include any combination of special-purpose hardware and/or general-purpose hardware with software implementing the functionality described herein.

For the sake of presentation, the detailed description uses terms like “determine” and “use” to describe computer operations in a computing system. These terms are high-level abstractions for operations performed by a computer, and should not be confused with acts performed by a human being. The actual computer operations corresponding to these terms vary depending on implementation.

### Example 4—Cloud Computing Environment

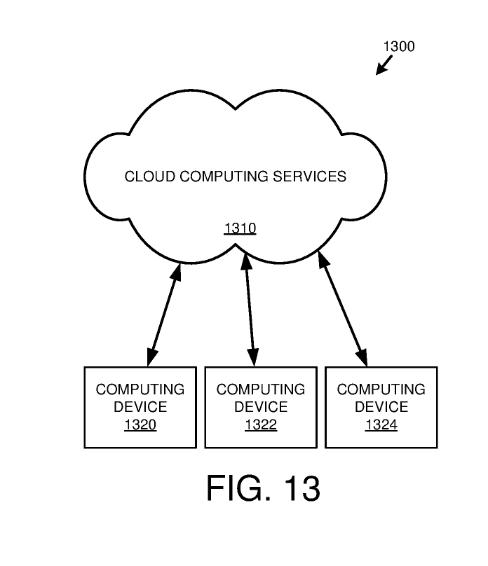

FIG. 13 depicts an example cloud computing environment 1300 in which the described technologies can be implemented. The cloud computing environment 1300 comprises cloud computing services 1310. The cloud computing services 1310 can comprise various types of cloud computing resources, such as computer servers, data storage repositories, networking resources, etc. The cloud computing services 1310 can be centrally located (e.g., provided by a data center of a business or organization) or distributed (e.g., provided by various computing resources located at different locations, such as different data centers and/or located in different cities or countries).

The cloud computing services 1310 are utilized by various types of computing devices (e.g., client computing devices), such as computing devices 1320, 1322, and 1324. For example, the computing devices (e.g., 1320, 1322, and 1324) can be computers (e.g., desktop or laptop computers), mobile devices (e.g., tablet computers or smart phones), or other types of computing devices. For example, the computing devices (e.g., 1320, 1322, and 1324) can utilize the cloud computing services 1310 to perform computing operations (e.g., data processing, data storage, and the like).

### Example 5—Implementations

Although the operations of some of the disclosed methods are described in a particular, sequential order for convenient presentation, it should be understood that this manner of description encompasses rearrangement, unless a particular ordering is required by specific language set forth herein. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media, such as tangible, non-transitory computer-readable storage media, and executed on a computing device (e.g., any available computing device, including smart phones or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 12, computer-readable storage media include memory 1220 and 1225, and storage 1240. The term computer-readable storage media does not include signals and carrier waves. In addition, the term computer-readable storage media does not include communication connections (e.g., 1270).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Python, Ruby, ABAP, SQL, Adobe Flash, or any other suitable programming language, or, in some examples, markup languages such as html or XML, or combinations of suitable programming languages and markup languages. Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and sub combinations with one another. The disclosed methods, apparatus, and systems are not limited to any specific aspect or feature or combination thereof, nor do the disclosed embodiments require that any one or more specific advantages be present or problems be solved.

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

What is claimed is:

1. One or more tangible, non-transitory, computer-readable storage media storing computer-executable instructions for causing a computing system, the computing system comprising one or more processing units and a memory, when programmed thereby to perform processing to transform a specification of a process model from a first format to a second format, the processing comprising:
receiving a specification of a process model in a first format, the process model comprising a plurality of related process steps; and
transforming the specification of the process model in the first format into a specification for the process model in a second format.

2. The one or more tangible, non-transitory computer-readable storage media of claim 1, the processing further comprising:
receiving user input defining the process model.

3. The one or more tangible, non-transitory computer-readable storage media of claim 1, wherein the specification of the process model in the first format is a graphical representation of the process model.

4. The one or more tangible, non-transitory computer-readable storage media of claim 1, wherein the specification of the process model in the second format is a computer-executable representation of the process model.

5. The one or more tangible, non-transitory computer-readable storage media of claim 1, the processing further comprising:
providing a user interface comprising a process definition palate, the process definition palate comprising a plurality of selectable graphical elements, each of the plurality of selectable graphical elements representing a particular process step.

6. The one or more tangible, non-transitory computer-readable storage media of claim 1, wherein the process model is a workflow model and the process steps are workflow items.

7. The one or more tangible, non-transitory computer-readable storage media of claim 1, wherein the processing further comprises:
executing the specification of the process model in the second format.

8. The one or more tangible, non-transitory computer-readable storage media of claim 7, wherein executing the specification of the process model in the second format comprises sending, to a collaboration component, an invitation to a user to become associated with the process model.

9. The one or more tangible, non-transitory computer-readable storage media of claim 7, wherein executing the specification of the process model in the second format comprises:
receiving user input requesting the status of a process step of the plurality of process steps;
determining the status of the process step; and
displaying the status of the process step to the user.

10. The one or more tangible, non-transitory computer-readable storage media of claim 7, wherein executing the specification of the process model in the second format comprises:
requesting a document associated with a process step of the plurality of process steps from a collaboration component;
receiving the requested document from the collaboration component; and
providing the requested document to a user.

11. The one or more tangible, non-transitory computer-readable storage media of claim 7, wherein executing the specification of the process model in the second format comprises:
receiving user input from a first user requesting information regarding a second user, the second user being associated with a first process step of the plurality of process steps;
retrieving information regarding the second user; and
displaying the information to the first user.

12. The one or more tangible, non-transitory computer-readable storage media of claim 11, wherein retrieving information regarding the second user comprises retrieving information from a central user information repository.

13. The one or more tangible, non-transitory computer-readable storage media of claim 11, wherein retrieving information regarding the second user comprises retrieving information from a collaboration component.

14. The one or more tangible, non-transitory computer-readable storage media of claim 1, wherein the specification of the process model in the first format comprises a markup language representation of the process model and the specification of the process model in the second format comprises a programming language representation of the process model.

15. A computing system that implements a workflow model transformation service, the computing system comprising:
memory;
one or more processing units coupled to the memory; and
one or more non-transitory computer readable storage media storing instructions that, when loaded into the memory, cause the one or more processing units to perform operations for:
receiving a specification of a workflow model in a first format, the workflow model comprising a plurality of workflow items; and
transforming the specification of the workflow model in the first format into a specification of the workflow model in a second format.

16. The computing system of claim 15, wherein the operations further comprise:
executing the specification of the workflow model in the second format.

17. The computing system of claim 15, wherein the specification of the workflow model in the first format comprises a graphical representation of the workflow model and the specification of the workflow model in the second format comprises a computer-executable representation of the workflow model.

18. In a computing system comprising a memory and one or more processors, a method of transforming a specification of a workflow model from a first format to a second format, the method comprising:
receiving a specification of a workflow model in a first format, the workflow model comprising a plurality of related process steps; and
transforming the specification of the workflow model in the first format into a specification of the workflow model in a second format.

19. The method of claim 18, wherein the specification of the workflow model in the first format comprises a graphical representation of the workflow model and the specification of the workflow model in the second format comprises a computer-executable representation of the workflow model.

20. The method of claim 19, further comprising receiving user input defining the workflow model in the specification of the workflow model in the first format.
